(19) United States
(12) Patent Application Publication
(10) Pub. No.: US 2009/0130335 A1
(43) Pub. Date: May 21, 2009

(54) PLASMA PROCESSING APPARATUS, PLASMA PROCESSING METHOD, DIELECTRIC WINDOW USED THEREIN, AND MANUFACTURING METHOD OF SUCH A DIELECTRIC WINDOW

(76) Inventors: Tomohiro Okumura, Osaka (JP); Hiroyuki Ito, Chiba (JP); Yuichiro Sasaki, Osaka (JP); Katsumi Okashita, Osaka (JP); Bunji Mizuno, Nara (JP); Ichiro Nakayama, Osaka (JP); Shogo Okita, Hyogo (JP); Hisao Nagai, Osaka (JP)

Correspondence Address: MCDERMOTT WILL & EMERY LLP, 600 13TH STREET, NW, WASHINGTON, DC, 20005-3096, US

(21) Appl. No.: 12/065,586

(22) PCT Filed: Sep. 1, 2006
(86) PCT No.: PCT/JP2006/317371

§ 371 Date: Sep. 16, 2008

(30) Foreign Application Priority Data
Sep. 1, 2005 (JP) 2005-254003

(51) Int. Cl. H05H 1/24; B05C 11/00

(52) U.S. Cl. 427/569; 118/708

(57) ABSTRACT

A method for performing plasma doping which is high in uniformity. A prescribed gas is introduced into a vacuum container from gas supply apparatus while being exhausted through an exhaust hole by a turbomolecular pump as an exhaust apparatus. The pressure in the vacuum container is kept at a prescribed value by a pressure regulating valve. High-frequency power of 13.56 MHz is supplied from a high-frequency power source to a coil which is disposed close to a dielectric window which is opposed to a sample electrode, whereby induction-coupled plasma is generated in the vacuum container. The dielectric window is composed of plural dielectric plates, and grooves are formed in at least one surface of at least two dielectric plates opposed to each other. Gas passages are formed by the grooves and a flat surface(s) opposed to the grooves, and gas flow-out holes which are formed in the dielectric plate that is closest to the sample electrode communicate with the grooves inside the dielectric window. The flow rates of gases that are introduced through the gas flow-out holes and the gas flow-out holes, respectively, can be controlled independently of each other, whereby the uniformity of processing can be increased.

### TECHNICAL FIELD

The present invention relates to a plasma processing apparatus, a plasma processing method, a dielectric window used therein, and a manufacturing method of such a dielectric window.

### BACKGROUND ART

Plasma doping methods for ionizing an impurity and introducing it into a solid at low energy are known as techniques for introducing an impurity into a surface layer of a solid sample (refer to Patent document 1, for example). FIG. 15 shows a general configuration of a plasma processing apparatus which is used for a plasma doping method as a conventional impurity introducing method disclosed in the above-mentioned Patent document 1. As shown in FIG. 15, a sample electrode 6 to be mounted with a sample 9 which is a silicon wafer is disposed inside a vacuum container 1. A gas supply apparatus 2 for supplying a doping material gas containing a desired element, such as a B₂H₆ gas, to the inside of the vacuum container 1 and a pump 3 for reducing the pressure in the vacuum container 1 are provided, whereby the pressure in the vacuum container 1 can be kept at a prescribed value. A microwave waveguide 51 radiates microwaves into the vacuum container 1 through a quartz plate 52 as a dielectric window. The interaction between the microwaves and a DC magnetic field formed by an electromagnet 53 produces microwave plasma with a magnetic field (electron cyclotron resonance plasma) 54 inside the vacuum container 1. A high-frequency power source 10 is connected to the sample electrode 6 via a capacitor 55, whereby the potential of the sample electrode 6 can be controlled. A gas supplied from the gas supply apparatus 2 is introduced into the vacuum container 1 through a gas introduction hole 56 and exhausted into the pump 3 through an exhaust hole 11.

In the above-configured plasma processing apparatus, a doping material gas such as a B₂H₆ gas that has been introduced through the gas introduction hole 56 is converted into plasma 54 by a plasma generating means which consists of the microwave waveguide 51 and the electromagnet 53 and boron ions in the plasma 54 are introduced onto the surface of the sample 9 by the high-frequency power source 10.

After a metal wiring layer is formed on the sample 9 into which the impurity has been introduced in the above-described manner, a thin oxide film is formed on the metal wiring layer in a prescribed oxidizing atmosphere. Then, gate electrodes are formed on the sample 9 by a CVD apparatus or the like, whereby MOS transistors, for example, are formed.

The gas supply method is important for the in-plane distribution control of plasma doping. The gas supply method is also important for the in-plane distribution control of other kinds of plasma processing. Various improvements have been made so far in this connection.

In the field of general plasma processing apparatus, induction-coupled plasma processing apparatus have been developed in which plural gas flow-out holes are provided so as to be opposed to a sample (refer to Patent document 2, for example). FIG. 16 shows a general configuration of a conventional dry etching apparatus disclosed in the above-mentioned Patent document 2. As shown in FIG. 16, the top wall of a vacuum processing chamber 1 is formed by laying a dielectric first top plate 7 on a dielectric second top plate 61. A multiple coil 8 is disposed over the upper, first top plate 7 and connected to a high-frequency power source 5. A process gas is supplied from a gas introduction path 13 toward the first top plate 7. A gas main path 14 is formed by one or plural cavities having one internal point as a passing point so as to communicate with the gas introduction path 13. Gas flow-out holes 62 are formed in the first top plate 7 so as to reach the gas main path 14 and the bottom surface of the first top plate 7. On the other hand, gas flow-out through-holes 63 are formed in the lower, second top plate 61 at the same positions as the gas flow-out holes 62. The vacuum chamber 1 can be exhausted along an exhaust path 64. A substrate stage 6 is disposed on the bottom of the vacuum chamber 1, and a substrate 9 as a subject of processing is held on the substrate stage 6.

With the above configuration, when the substrate 9 is processed, the substrate 9 is mounted on the substrate stage 6 and vacuum exhausting is performed along the exhaust path 64. After the vacuum exhausting, a process gas for plasma processing is introduced along the gas introduction path 13. The process gas spreads uniformly in the first top plate 7 via the gas main path 14 which is formed in the first top plate 7, uniformly reaches the interface between the first and second top plates 7 and 61 via the gas flow-out holes 62, passes through the gas flow-out through-holes 63 which are formed in the second top plate 61, and is introduced to the substrate 9 so as to be distributed uniformly there. High-frequency power is applied to the coil 8 by the high-frequency power source 5 and the gas inside the vacuum processing chamber 1 is excited by electromagnetic waves that are emitted from the coil 8 into the vacuum processing chamber 1, whereby plasma is generated under the top plates 7 and 61 and the substrate 9 mounted on the substrate stage 6 which is disposed inside the vacuum processing chamber 1 is processed by the plasma.

Parallel-plate, capacitance-coupled plasma processing apparatus have also been invented which are configured in such a manner that the flow rate of a gas that is flowed out toward a central portion of a sample can be controlled independently of the flow rate of a gas that is flowed out toward a peripheral portion of the sample (refer to Patent document 3, for example). FIG. 17 shows a general configuration of a conventional dry etching apparatus disclosed in the above-mentioned Patent document 3. As shown in FIG. 17, a top electrode 128 which also serves as a gas supply member is an integral body consisting of a rectangular frame 129 which corresponds to a substrate 114 to be processed, a shower plate 130 which closes the bottom opening of the frame 129 and through which many gas flow-out holes 131 are formed approximately uniformly, and an annular partition wall 132 which divides the space enclosed by the frame 129 and the shower plate 130 into two (i.e., inside and outside) regions. The internal space between the top electrode 128 and the top plate of the vacuum chamber 101 is divided into a central gas space 133 and a peripheral gas space 134 by the partition wall 132.

The central gas space 133 is provided, at the center, with a single gas introduction member 137 for supplying a reaction gas G. The peripheral gas space 134 is provided with two gas introduction members 138 and 139 for supplying the reaction gas G, at side positions that are symmetrical with respect to the gas introduction member 137. Gas supply systems 106 each of which consists of a primary valve 108, a mass flow controller (flow rate regulator) 109, and a secondary valve 110 are pipe-connected to the respective gas introduction members 137-139, whereby the reaction gas G is supplied to each of the gas introduction members 137-139 from a gas supply source 107.

On the other hand, the present inventors have proposed an induction-coupled plasma processing apparatus in which one dielectric window is formed by bonding two dielectric plates together (Patent document 4). FIG. 18 shows a general configuration of a conventional dry etching apparatus. As shown in FIG. 18, a gas introduction path is composed of a first gas introduction passage 220 which is a hollow passage formed in a first dielectric plate 200 and having a diameter of 4 mm, for example, and serves to introduce a gas from outside the dielectric plate 160a to approximately its center and a second gas introduction passage 230 which is a hollow passage formed in a second dielectric plate 210 and having a diameter of 4 mm, for example, and serves to introduce, to gas flow-out holes 240, the gas that has been introduced to approximately the center of the dielectric plate 160a. As shown in FIG. 18(c) which is a sectional view of the dielectric plate 160a (taken along line A-A′ in FIG. 18(b)), an opening portion of each gas flow-out hole 240 is tapered so as to increase in diameter toward the opening in such a manner that its maximum diameter, minimum diameter, and height measure 8 mm, 0.5 mm, and 5 mm, respectively.

Patent document 1: U.S. Pat. No. 4,912,065

Patent document 2: JP-A-2001-15493

Patent document 3: JP-A-2000-294538

Patent document 4: JP-A-2005-209885

### DISCLOSURE OF THE INVENTION

### Problems to be Solved by the Invention

However, the conventional method (plasma processing apparatus disclosed in Patent document 1) had a problem that the sample-surface uniformity of the introduction amount (dose) of an impurity was low. Since the gas flow-out hole 56 is disposed in a directive manner, the dose became high in a portion close to the gas flow-out hole 56 and became low in a portion away from the gas flow-out hole 56.

In view of the above, plasma doping was attempted by using the plasma processing apparatus as disclosed in Patent document 2. However, the dose was high in a central portion of a substrate and was low in its peripheral portion; that is, the dose was low in uniformity.

In the plasma processing apparatus disclosed in Patent document 3, the uniformity was increased because the content of a gas containing an impurity in a central portion and that in a peripheral portion can be controlled independently of each other. However, there remained a problem that the processing speed was not as high as a practical level because parallel-plate, capacitance-coupled plasma is used.

In the plasma processing apparatus of Patent document 4 shown in FIG. 18 in which the single dielectric window is formed by bonding the two dielectric plates together, the grooves formed in the two dielectric plates are overlapped with each other so as to communicate with each other to form a single groove. Since all the gas flow-out holes 240 communicate with the unified groove, it is difficult to attain a sufficient level of uniformity, which is essentially the same situation as the plasma processing apparatus disclosed in Patent document 2 is in. Since the unified groove is formed by overlapping the grooves of two dielectric plates with each other, it is difficult to control the conductance of the passage because it is varied due to only a small positional deviation.

The present invention has been made in view of the above circumstances, and an object of the invention is therefore to provide a plasma processing apparatus capable of performing plasma doping which is high in the uniformity of the concentration of an impurity introduced in a surface layer of a sample and plasma processing which is high in the in-plane uniformity of processing, a dielectric window used therein, and a manufacturing method of such a dielectric window.

### Means for Solving the Problems

To attain the above object, the invention provides a plasma processing apparatus having a vacuum container, a sample electrode which is disposed inside the vacuum container and is to be mounted with a sample, a gas supply apparatus for supplying a gas to inside the vacuum container, plural gas flow-out holes formed in a dielectric window which is opposed to the sample electrode, an exhaust apparatus for exhausting the vacuum container, a pressure control device for controlling pressure in the vacuum container, and an electromagnetic coupling device for generating an electromagnetic field inside the vacuum container, characterized in that the dielectric window is composed of plural dielectric plates, grooves are formed in at least one surface of at least two confronting dielectric plates, gas passages are formed by the grooves and a flat surface opposed to the grooves, and the gas flow-out holes which are formed in a dielectric plate that is closest to the sample electrode communicate with the grooves inside the dielectric window.

This configuration can provide a plasma processing apparatus capable of performing plasma doping which is high in the uniformity of the concentration of an impurity introduced in a surface layer of a sample and plasma processing which is high in the in-plane uniformity of processing. It is desirable that gas supply portions for supplying the grooves with gases coming from the gas supply apparatus be provided, conductances of gas passages of the grooves from the gas supply portions to the gas flow-out holes be set identical, and gas plasma generated by the electromagnetic coupling device be introduced to the sample and plasma processing be performed on the surface of the sample. The term “dielectric plate” means a plate-shaped body made of a dielectric.

The invention includes a plasma processing apparatus which is based on the above plasma processing apparatus and in which the grooves form plural passage systems that do not communicate with each other.

This configuration makes it possible to independently control the gas supply rates of the respective passage systems.

The invention includes a plasma processing apparatus which is based on the above plasma processing apparatus and in which each of the passage systems is composed of plural gas passages that do not allow the grooves to communicate with each other.

This configuration makes it possible to independently control the gas supply rates of the respective passage systems while controlling the conductance of each gas passage.

The invention includes a plasma processing apparatus which is based on the above plasma processing apparatus and in which the passage systems are formed so that conductances of gas passages of the grooves from the gas supply portions to the gas flow-out holes can be controlled independently of each other.

With this configuration, since the conductances of the respective gas passages can be controlled independently of each other, the distribution of the supply rate of a gas supplied from each gas supply hole can be controlled and hence a uniform plasma distribution can be obtained easily. The gas supply rate need not always be controlled so as be uniform. It is possible to obtain a uniform plasma distribution by controlling the gas supply rates so that they cancel out a variation of plasma-generated charges.

The invention includes a plasma processing apparatus which is based on the above plasma processing apparatus and in which the passage systems are formed so that conductances of gas passages of the grooves from the gas supply portions to the gas flow-out holes can be controlled independently of each other, and gases that are flowed out of the passage systems have an approximately uniform distribution on a surface of the sample.

This configuration can produce a uniform gas supply rate distribution on the sample surface and hence can realize uniform plasma processing.

The invention includes a plasma processing apparatus which is based on the above plasma processing apparatus and in which the gas flow-out holes of the passage systems are arranged so as to be located on concentric circles.

This configuration can make the gas supply rate of the gas flow-out holes uniform in the sample surface.

The invention includes a plasma processing apparatus which is based on the above plasma processing apparatus and in which the gas flow-out holes communicate with first and second passage systems which are arranged so as to assume concentric circles, and the first passage system has the gas supply portion inside the gas flow-out holes on the concentric circle and the second passage system has the gas supply portion outside the gas flow-out holes on the concentric circle.

In this configuration, the first passage system which is located inside has the gas supply portion on the side of its center and the second passage system which is located outside has the gas supply portion outside. Therefore, uniform gas supply can be realized by the two passage systems having the gas flow-out holes which are located on concentric circles.

The invention includes a plasma processing apparatus which is based on the above plasma processing apparatus and in which conductances of gas passages of the grooves from the gas supply portions to the gas flow-out holes are set identical.

This configuration can realize uniform gas supply from the gas flow-out holes.

The invention includes a plasma processing apparatus which is based on the above plasma processing apparatus and in which the grooves are formed in only one of first and second dielectric plates, the other dielectric plate has a flat surface, and the passages are formed by bonding the first and second dielectric plates together.

With this configuration, the conductance of each passage is not varied by a slight positional deviation of the bonding. Therefore, a plasma processing method can be provided which can easily perform uniform gas supply.

The invention includes a plasma processing apparatus which is based on the above plasma processing apparatus and in which the first passage system has plural radial groove portions which extend radially from a center of the dielectric plate and a first circular groove portion which assumes a circular arc and communicates with the radial groove portions, and gas flow-out holes are formed so as to communicate with the first circular groove portion; and in which the gas supply portion communicates with the radial groove portions at the center of the dielectric plate.

This configuration enables gas supply that is even higher in uniformity.

The invention includes a plasma processing apparatus which is based on the above plasma processing apparatus and in which the second passage system has a second circular arc groove portion which assumes a circular arc and is formed outside the first circular arc groove portion and an outer groove which extends outward from the second circular arc groove portion, and that the gas supply portion communicates with the outer groove.

This configuration can make the conductance of each of the first and second passage systems uniform and hence can produce a gas distribution that is highly accurate and highly reliable.

In the above plasma processing apparatus according to the invention, it is desirable that the electromagnetic coupling device be a coil. Alternatively, the electromagnetic coupling device may be an antenna.

This configuration can realize a high processing speed.

The above plasma processing apparatus is particularly effective in plasma doping.

In the above plasma processing apparatus, preferably, it is desirable that independent gas supply apparatus be connected to the respective grooves. Alternatively, a control valve for varying a conductance ratio between gas passages that allow the gas supply apparatus to communicate the respective grooves may be provided.

This configuration can provide a plasma processing apparatus capable of performing plasma doping which is even higher in the uniformity of the concentration of an impurity introduced in a surface layer of a sample and plasma processing which is even higher in the in-plane uniformity of processing.

In the above plasma processing apparatus, preferably, it is desirable that parts of a gas passage that allows the gas supply apparatus to communicate with each of the grooves be a hole that penetrates through a peripheral window frame for supporting the dielectric window and a hole that penetrates through a dielectric plate or plates.

This configuration makes such trouble as leakage less likely.

It is desirable that when each of the grooves is divided into a portion (a) where through-holes that connect the groove to the gas flow-out holes are arranged approximately at regular intervals and a portion (b) where no through-holes for connecting the groove to the gas flow-out holes are arranged, the connecting portion of the groove and the gas supply apparatus communicate with the portion (a) via plural paths as the portion (b) which have approximately the same lengths. Even preferably, it is desirable that connecting portions of the portions (a) and (b) be arranged so as to be balanced almost completely with respect to the portion (a).

This configuration can provide a plasma processing apparatus capable of performing plasma doping which is even higher in the uniformity of the concentration of an impurity introduced in a surface layer of a sample and plasma processing which is even higher in the in-plane uniformity of processing.

Preferably, it is desirable that through-holes that communicate with a groove formed in one surface of a certain dielectric plate be located at positions having approximately the same distances from the center of the dielectric window.

This configuration can provide a plasma processing apparatus capable of performing plasma doping which is even higher in the uniformity of the concentration of an impurity introduced in a surface layer of a sample and plasma processing which is even higher in the in-plane uniformity of processing.

Preferably, it is desirable that the dielectric plates be made of quartz glass.

This configuration can realize a dielectric window which is high is mechanical strength and can prevent mixing of unnecessary impurities.

Preferably, it is desirable that the dielectric window be composed of two dielectric plates; and when the two dielectric plates are referred to as dielectric plates A and B in ascending order of distance from the sample electrode, a first groove be formed in a surface of the dielectric plate A that is located on the opposite side to the sample electrode and a second groove be formed is a surface of the dielectric plate B that is opposed to the sample electrode. Even preferably, it is desirable that the first groove communicate with part of the gas flow-out holes via through-holes formed in the dielectric plate A and the second groove communicate with the other gas flow-out holes via through-holes formed in the dielectric plate A.

This configuration makes it possible to construct the dielectric window easily at a low cost.

An alternative configuration is such that the dielectric window is composed of two dielectric plates; and when the two dielectric plates are referred to as dielectric plates A and B in ascending order of distance from the sample electrode, first and second grooves are formed in a surface of the dielectric plate A that is located on the opposite side to the sample electrode or opposed to the sample electrode. In this case, it is desirable that the first and second grooves communicate with the gas flow-out holes via through-holes formed in the dielectric plate A.

This configuration makes it possible to construct the dielectric window easily at a low cost.

Another alternative configuration is such that the dielectric window is composed of three dielectric plates; and when the three dielectric plates are referred to as dielectric plates A, B, and C in ascending order of distance from the sample electrode, a first groove is formed in a surface of the dielectric plate A that is located on the opposite side to the sample electrode, a second groove is formed in a surface of the dielectric plate B that is opposed to the sample electrode, a third groove is formed in a surface of the dielectric plate B that is located on the opposite side to the sample electrode, and a fourth groove is formed in a surface of the dielectric plate C that is opposed to the sample electrode. In this case, it is desirable that the first and second grooves communicate with parts of the gas flow-out holes via through-holes formed in the dielectric plate A and the third and fourth grooves communicate with the other parts of gas flow-out holes via through-holes formed in the dielectric plates A and B.

This configuration makes it possible to construct the dielectric window easily at a low cost.

A further alternative configuration is such that the dielectric window is composed of three dielectric plates; and when the three dielectric plates are referred to as dielectric plates A, B, and C in ascending order of distance from the sample electrode, first and second grooves are formed in a surface of the dielectric plate A that is located on the opposite side to the sample electrode or a surface of the dielectric plate B that is opposed to the sample electrode and third and fourth grooves are formed in a surface of the dielectric plate B that is located on the opposite side to the sample electrode or a surface of the dielectric plate C that is opposed to the sample electrode. In this case, it is desirable that the first and second grooves communicate with parts of the gas flow-out holes via through-holes formed in the dielectric plate A and the third and fourth grooves communicate with the other parts of gas flow-out holes via through-holes formed in the dielectric plates A and B.

This configuration makes it possible to construct the dielectric window easily at a low cost.

The above plasma processing apparatus may be such that the first passage system has plural first radial groove portions which extend radially from a center of the dielectric plate and second radial groove portions which extend radially from an outer end of each of the first radial groove portions so as to communicate with the first radial groove portions, and gas flow-out holes are formed so as to communicate with tips of the second radial groove portions; and that the gas supply portion communicates with the first radial groove portions at the center of the dielectric plate.

This configuration makes it possible to form passages that are constant in conductance and are not prone to interfere with each other. Either of the first and second passage systems may have radial groove portions having the above structure.

The invention also provides a plasma processing method for processing a substrate to be processed by generating gas plasma containing impurity ions by operating an electromagnetic coupling means opposed to a sample electrode which is disposed inside a vacuum container and mounted with the substrate to be processed while supplying a gas containing an impurity to inside the vacuum container at a prescribed rate and a prescribed concentration and controlling pressure in the vacuum container to a prescribed value, characterized by giving a distribution to a concentration or a supply rate of a gas containing the impurity that is supplied to a surface of the substrate to be processed.

A plasma processing method according to the invention which is based on the above plasma processing method is characterized in that an inside area and an outside area of the substrate to be processed is given different distributions of the concentration or the supply rate of the gas supplied.

A plasma processing method according to the invention which is based on the above plasma processing method is characterized in that the gas concentration distribution is such that the concentration has a peak in a region having a prescribed distance from a center of the substrate to be processed.

A plasma processing method according to the invention which is based on the above plasma processing method is characterized by forming an impurity region having a depth of 20 nm or less as measured from the surface of the substrate to be processed using the gas plasma.

The invention also provides a dielectric window formed by laminating at least two dielectric plates, characterized in that grooves are formed in at least one surface of at least two dielectric plates, and gas flow-out holes which are formed in a surface of a dielectric plate that is one surface of the dielectric window communicate with the grooves inside the dielectric window.

This configuration can provide a plasma processing apparatus capable of performing plasma doping which is high in the uniformity of the concentration of an impurity introduced in a surface layer of a sample and plasma processing which is high in the in-plane uniformity of processing.

In the dielectric window according to the invention, preferable, it is desirable that the dielectric plates be made of quartz glass.

This configuration can realize a dielectric window which is high is mechanical strength and can prevent mixing of unnecessary impurities.

The invention provides a manufacturing method of a dielectric window, characterized by comprising the steps of forming through-holes in a dielectric plate; forming grooves in a dielectric plate; and placing in a vacuum and heating the dielectric plate in which the through-holes are formed and the dielectric plate in which the grooves are formed while bringing at least one surfaces of the dielectric plates in contact with each other, and thereby joining the contacting surfaces together.

This constitution can realize a dielectric window which is high in mechanical strength easily at a low cost.

The invention provides another manufacturing method of a dielectric window, characterized by comprising the steps of forming through-holes and grooves in a dielectric plate; and placing in a vacuum and heating the dielectric plate in which the through-holes and the grooves are formed and another dielectric plate while bringing at least one surfaces of the dielectric plates in contact with each other, and thereby joining the contacting surfaces together.

This constitution can realize a dielectric window which is high in mechanical strength easily at a low cost.

### BRIEF DESCRIPTION OF THE DRAWINGS

FIG. 1 is a sectional view showing the configuration of a plasma doping chamber used in a first embodiment of the present invention.

FIG. 2 is a sectional view showing the structure of a dielectric window according to the first embodiment of the invention.

FIG. 3 is sectional views showing the structures of dielectric plates according to the first embodiment of the invention.

FIG. 4 is a sectional view showing the structure of a dielectric window according to a second embodiment of the invention.

FIG. 5 is sectional views showing the structures of dielectric plates according to the second embodiment of the invention.

FIG. 6 is a sectional view showing the structure of a dielectric window according to a third embodiment of the invention.

FIG. 7 is sectional views showing the structures of dielectric plates according to the third embodiment of the invention.

FIG. 8 is a sectional view showing the structure of a dielectric window according to a fourth embodiment of the invention.

FIG. 9 is sectional views showing the structures of dielectric plates according to the fourth embodiment of the invention.

FIG. 10 is a sectional view showing the structure of a dielectric window according to a fifth embodiment of the invention.

FIG. 11 is sectional views showing the structures of dielectric plates according to the fifth embodiment of the invention.

FIG. 12 is a sectional view showing the configuration of a plasma doping chamber according to another embodiment of the invention.

FIG. 13 is a sectional view showing the structure of a dielectric window according to a sixth embodiment of the invention.

FIG. 14 is sectional views showing the structures of dielectric plates according to a sixth embodiment of the invention.

FIG. 15 is a sectional view showing the configuration of a conventional plasma doping apparatus.

FIG. 16 is a sectional view showing the configuration of a conventional dry etching apparatus.

FIG. 17 is a sectional view showing the configuration of another conventional dry etching apparatus.

FIG. 18 is perspective views and a sectional view showing the structure of a conventional dielectric window.

### DESCRIPTION OF SYMBOLS

1: Vacuum container
2: Gas supply apparatus
3: Turbomolecular pump
4: Pressure regulating valve
5: Plasma source high-frequency power source
6: Sample electrode
7: Dielectric window
8: Coil
9: Wafer
10: Sample electrode high-frequency power source
11: Exhaust hole
12: Pole
13: Pipe
14: Groove
15: Gas flow-out hole
16: Gas supply apparatus
17: Pipe
18: Groove
19: Gas flow-out hole
20: Through-hole
21: Through-hole

### BEST MODE FOR CARRYING OUT THE INVENTION

Embodiments of the present invention will be hereinafter described with reference to the drawings.

### Embodiment 1

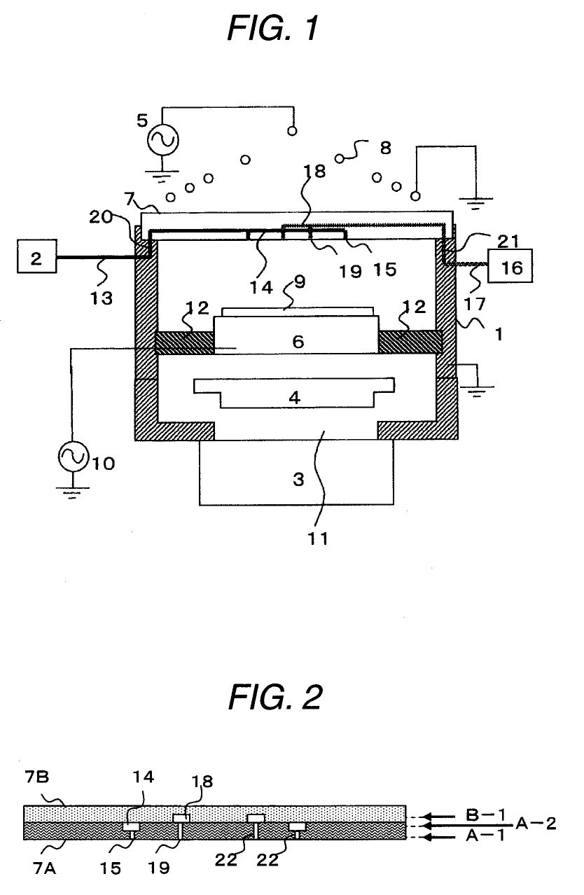

A first embodiment of the invention will be described below with reference to FIGS. 1-3.

FIG. 1 is a sectional view of a plasma processing apparatus used in the first embodiment of the invention. This plasma processing apparatus includes a device for making uniform the supply of a gas from gas flow-out holes, and is characterized as follows. Let a groove 14 and a groove 18 be divided into a groove portion 14a and a groove portion 18a (groove portions (a)), respectively, where through-holes 22 that connect the groove 14 or 18 to gas flow-out holes 15 or 19 are arranged approximately at regular intervals and a groove portion 14b and a groove portion 18b (groove portions (b)), respectively, where no through-holes for connecting the groove 14 or 18 to the gas flow-out holes 15 or 19 are arranged. Then, a connecting portion of the groove 14 or 18 and a gas supply apparatus 2 or 16 communicates with the groove portion 14a or 18a (groove portion (a)) via plural paths (groove portion (b)) which have approximately the same lengths, and connecting portions of the groove portions (a) and (b) are arranged so as to be balanced almost completely with respect to the groove portion (a).

Referring to FIG. 1, a prescribed gas is introduced into a vacuum container 1 from a gas supply apparatus 2 while being exhausted by a turbomolecular pump 3 as an exhaust apparatus. The pressure in the vacuum container 1 can be kept at a prescribed value by a pressure regulating valve 4 as a pressure control device. High-frequency power of 13.56 MHz is supplied from a high-frequency power source 5 to a coil 8 disposed close to a dielectric window 7 which is opposed to a sample electrode 6, whereby induction-coupled plasma can be generated in the vacuum container 1. A silicon wafer 9 as a sample is mounted on the sample electrode 6. A high-frequency power source 10 for supplying high-frequency power to the sample electrode 6 is provided to function as a voltage source for controlling the potential of the sample electrode 6 so that the wafer 9 as the sample is given a negative potential with respect to the plasma. With the above arrangement and settings, ions in the plasma are accelerated toward and caused to collide with the surface of the sample, whereby a surface layer of the sample can be processed. Plasma doping can be performed by using a gas including diborane or phosphine. A gas that is supplied from the gas supply apparatus 2 is exhausted into the pump 3 through an exhaust hole 11. The turbomolecular pump 3 and the exhaust hole 11 are disposed right under the sample electrode 6, and the pressure regulating valve 4 is an elevating value that is disposed right under the sample electrode 6 and right over the turbomolecular pump 3. The sample electrode 6 is fixed to the vacuum container 1 by four support poles 12.

When plasma doping is performed, the flow rate of a gas including an impurity material gas is controlled to a prescribed value by a flow rate controller (mass flow controller) that is provided inside the gas supply apparatus 2. In general, a gas obtained by diluting an impurity material gas with helium, for example, a gas obtained by diluting diborane (B₂H₆) to 0.5% with helium, is used as an impurity material gas. Its flow rate is controlled by a first mass flow controller and the flow rate of helium is controlled by a second mass flow controller. The gases whose flow rates are controlled by the first and second mass controllers are mixed with each other in the gas supply apparatus 2. A mixed gas is guided into a groove 14 as a gas main path via a pipe (gas introduction path) 13, and then guided into the vacuum container 1 through gas flow-out holes 15 via plural holes that communicate with the groove 14 (gas main path). The plural gas flow-out holes 15 are formed so as to flow-out the gas toward the sample 9 from the surface that is opposed to the sample electrode 6. The pipe 13 and the groove 14 communicate with each other via a through-hole 20 which is located between the dielectric window 7 and the pipe 13. That is, part of the gas passage that allows the gas supply apparatus 2 to communicate with the groove 14 is formed by a hole that penetrates through a top portion of the vacuum container 1 that also serves as a window frame whose peripheral portion supports the dielectric window 7 and a hole (described later) that penetrates through a dielectric plate(s). With this configuration, the vacuum container 1 is provided with a connection flange (i.e., a structure that a connection flange is in contact with the dielectric window 7 is avoided), which makes such trouble as leakage less likely.

A mixing gas whose flow rate is controlled by another mass flow controller is guided to a groove 18 as a gas main path via a pipe (gas introduction path) 17 and then guided into the vacuum container 1 through gas flow-out holes 19 via plural holes that communicate with the groove 18. The plural gas flow-out holes 19 are formed so as to flow-out the gas toward the sample 9 from the surface that is opposed to the sample electrode 6. The pipe 17 and the groove 18 communicate with each other via a through-hole 21 which is located between the dielectric window and the pipe 17. That is, part of the gas passage that allows a gas supply apparatus 16 to communicate with the groove 18 is formed by a hole that penetrates through the top portion of the vacuum container 1 that also serves as the window frame whose peripheral portion supports the dielectric window 7 and a hole (described later) that penetrates through a dielectric plate(s). Naturally, a window frame for supporting the dielectric window 7 by its peripheral portion may be a component that is separate from the vacuum container 1.

FIG. 2 shows a detailed cross section of the dielectric window 7. As is apparent from this figure, the dielectric window 7 is composed of two dielectric plates 7A and 7B. The grooves 14 and 18 which are gas passages as first and second passage systems which are formed independently of each other in the single surfaces of the dielectric plates 7A and 7B, respectively. The gas flow-out holes 15 and 19 formed in the dielectric plate 7A which is closest to the sample electrode 6 communicate with the grooves 14 and 18 inside the dielectric window 7.

The above structure realizes the state that the gas supply apparatus 2 or 16 are connected to the respective grooves independently of each other and thereby makes it possible to perform a gas flow-out control very precisely.

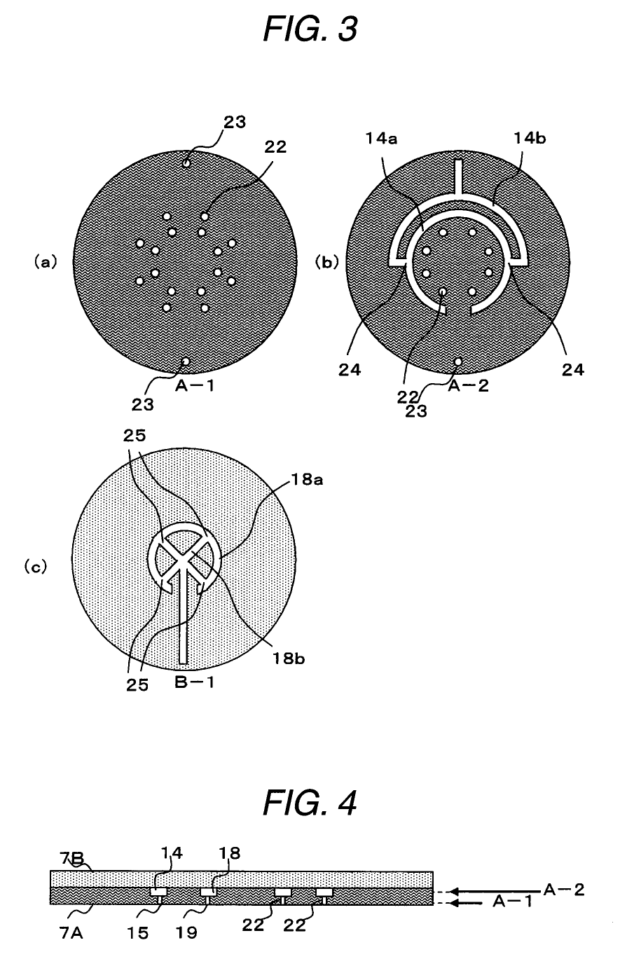

FIGS. 3(a)-3(c) are sectional views, taken along respective lines A-1, A-2, and B-1 in FIG. 2, of the dielectric plates 7A and 7B which constitute the dielectric window 7. As shown in FIG. 3(a) which is a sectional view taken at position A-1, through-holes 22 which connect the grooves 14 and 18 to the gas flow-out holes 15 and 19 and through-holes 23 which allow the grooves 14 and 18 to communicate with the window frame are formed in a lower layer (located on the sample electrode side) of the dielectric plate 7A.

As shown in FIG. 3(b) which is a sectional view taken at position A-2, (first grooves 14a and 14b) are formed in an upper layer (located on the opposite side to the sample electrode 6) of the dielectric plate 7A. As shown in FIG. 3(a) which is a sectional view taken at position A-1, the through-holes 22 that connect the groove 14 to the gas flow-out holes 15 are formed right under the groove 14a. That is, the groove 14a is a portion where the through-holes 22 that connect the groove 14 to the gas flow-out holes 15 are arranged approximately at regular intervals. The groove 14b is a portion where no through-holes for connecting the groove 14 to the gas flow-out holes 15 are arranged. As is apparent from FIG. 3(b), the connecting portion of the gas supply apparatus 2 and the groove 14 communicates with the groove 14a via two paths (groove 14b) which have approximately the same lengths. That is, the two paths from the connecting portion of the groove 14 and the through-hole 23 which allows the window frame to communicate with the groove 14 to connecting portions 24 of the grooves 14a and 14b have approximately the same lengths.

Furthermore, the connecting portions 24 of the grooves 14a and 14b are arranged so as to be balanced almost completely with respect to the groove 14a, which is effective in suppressing variation in the flow rates of gases supplied to the respective through-holes 22 when a gas is supplied to the vacuum container 1. Although in this embodiment the connecting portion of the gas supply apparatus 2 and the groove 14 communicates with the groove 14a via the two paths (groove 14b), the former may communicate with the latter via three or more paths. Still further, the through-holes 22 that connect the groove 18 to the gas flow-out holes 19 are arranged at positions that are closer to the center of the dielectric plate 7A than the groove 14a is. These through-holes 22 are arranged at the positions having approximately the same distance from the center of the dielectric window 7.

As shown in FIG. 3(c) which is a sectional view taken at position B-1, (second) grooves 18a and 18b are formed in a lower layer (located on the sample electrode side) of the dielectric plate 7B. As shown in FIG. 3(b) which is a sectional view taken at position A-2, the through-holes 22 that connect the groove 18 to the gas flow-out holes 19 are formed right under the groove 18a. That is, the groove 18a is a portion where the through-holes 22 that connect the groove 18 to the gas flow-out holes 19 are arranged approximately at regular intervals. The groove 18b is a portion where no through-holes for connecting the groove 18 to the gas flow-out holes 19 are arranged.

As is apparent from FIG. 3(c) which is a sectional view taken at position B-1, the connecting portion of the gas supply apparatus 16 and the groove 18 communicates with the groove 18a via four paths (groove 18b) which have approximately the same lengths. That is, the four paths from the connecting portion of the groove 18 and the through-hole 23 which allows the window frame to communicate with the groove 18 to connecting portions 25 of the grooves 18a and 18b have approximately the same lengths.

Furthermore, the connecting portions 25 of the grooves 18a and 18b are arranged so as to be balanced almost completely with respect to the groove 18a, which is effective in suppressing variation in the flow rates of gases supplied to the respective through-holes 22 when a gas is supplied to the vacuum pump 1. Although in this embodiment the connecting portion of the gas supply apparatus 16 and the groove 18 communicates with the groove 18a via the four paths (groove 18b), the former may communicate with the latter via an arbitrary number (larger than or equal to 2) of paths.

As is apparent from FIGS. 3(b) and 3(c) which are sectional views taken at positions A-2 and B-1, respectively, the groove 14b is formed outside the groove 14a and the groove 18b is formed inside the groove 18a. Forming, in this manner, the grooves in the joining surfaces of the dielectric plates 7A and 7B so that they do not interfere with each other makes it possible to independently control the rates at which gases are supplied from the gas flow-out holes 15 and the gas flow-out holes 19.

Each of the dielectric plates 7A and 7B is made of quartz glass. The use of quartz glass can prevent mixing of unnecessary impurities because high-purity quartz glass can be produced easily and silicon and oxygen as its constituent elements hardly become contamination sources of semiconductor devices. Furthermore, the use of quartz glass makes it possible to realize a dielectric window having high mechanical strength.

Next, a procedure for manufacturing the above-described dielectric window 7 will be described. First, a groove 14 is formed in one surface of the dielectric plate 7A and through-holes 22 and 23 are also formed. And a groove 18 is formed in one surface of the dielectric plate 7B. Then, the dielectric plate 7A in which the through-holes 22 and 23 are formed and the dielectric plate 7B in which the groove 18 is formed are put into a vacuum and heated to about 1,000° C. while the surface, formed with the groove 14, of the dielectric plate 7A in which the through-holes have been formed and the surface, formed with the groove 18, of the dielectric plate 7B are brought in contact with each other. The contacting surfaces can thus be joined to each other. The dielectric window 7 produced in this manner is high is mechanical strength and the joining surfaces do not peel off each other in ordinary plasma processing.

In the above plasma processing apparatus, the temperature of the sample electrode 6 was kept at 25° C., a He-diluted B₂H₆ gas and a He gas were supplied to the inside of the vacuum container 1 at 5 sccm and 100 sccm, respectively, through the gas flow-out holes 15 and at 1 sccm and 20 sccm, respectively, through the gas flow-out holes 19, the pressure in the vacuum container 1 was kept at 0.7 Pa, and high-frequency power of 1,400 W was supplied to the coil 8, whereby plasma was generated in the vacuum container 1. Furthermore, high-frequency power of 150 W was supplied to the sample electrode 6, whereby boron ions in the plasma were caused to collide with the surface of a wafer 9 and boron was successfully introduced into a surface layer of the wafer 9. The in-plane uniformity of the concentration (dose) of boron that has been introduced into the surface layer of the wafer 9 was as good as ±0.65%.

For comparison, processing was performed while a He-diluted B₂H₆ gas and a He gas were supplied at the same flow rates (He-diluted B₂H₆: 6 sccm; He gas: 120 sccm) through the gas flow-out holes 15 and the gas flow-out holes 19. The dose increased as the position goes closer to the center of a wafer 9 and its in-plane uniformity was ±2.2%.

The fact that independently controlling the flow rate for a portion close to the center of a wafer and that for a portion far from the center is very important in securing high uniformity of a process is particularly remarkable in plasma doping. In the case of dry etching, only a very small amount of radicals are necessary for exciting an ion-assisted reaction. In particular, in the case of using a high-density plasma source such as an induction-coupled one, it is rare that the uniformity of an etching rate distribution is lowered by the manner of arrangement of gas flow-out holes. In the case of plasma CVD, a thin film is deposited on a substrate while the substrate is heated. Therefore, as long as the substrate temperature is uniform, it is rare that the uniformity of a deposition rate distribution is lowered to a large extent by the manner of arrangement of gas flow-out holes.

In this embodiment, the concentration of B₂H₆ in a gas that is introduced from the gas flow-out holes 19 near the center of the dielectric window 7 is set equal to that in a gas that is introduced from the gas flow-out holes 15 which are away from the center of the dielectric window 7. However, in the apparatus having the above-described configuration, these two kinds of B₂H₆ concentrations can be controlled independently of each other.

That is, the gas concentration or gas supply rate of a gas containing an impurity which is supplied to the surface of a substrate to be processed may have a certain distribution. For example, the distribution of the gas concentration or the gas supply rate may be such that the concentration or supply rate of a gas supplied to an inside area of a substrate to be processed is different from that of a gas supplied to an outside area of the substrate.

It is desirable that the above-mentioned gas concentration be given such a distribution that a peak concentration is located in a region having a prescribed distance from the center of a substrate to be processed. In this case, since a gas is supplied so as to have such a concentration distribution that a peak concentration is located in a region where the concentration would be low unless this measure were taken, a uniform concentration distribution can be attained in the surface of a substrate processed.

The invention is particularly effective in a case that impurity regions are formed in a layer whose depth from the surface of a substrate to be processed is less than or equal to 20 nm.

Incidentally, in dry etching of an insulating film, there may occur a problem that the etching characteristics vary due to deposition of a carbon-fluoride-based thin film on the inner surface of the vacuum container. However, the influence of a deposition film is relatively small because the concentration of a carbon-fluoride-based gas in a mixed gas that is introduced into the vacuum container is as low as several percent. On the other hand, in plasma doping, the influence of a deposition film is relatively great because the concentration of an impurity material gas that is mixed with an inert gas to be introduced into the vacuum container is less than 1% (less than 0.1% in the case where it is required to control the dose with high accuracy). It is necessary that the concentration of an impurity material gas that is mixed with an inert gas to be introduced into the vacuum container be higher than 0.001%. If the concentration is lower than this value, to obtain a desired dose processing needs to be performed for an extremely long time.

It has been found that a saturation dose in what is called a self-regulation phenomenon that the dose that is obtained in processing a single substrate is saturated as the processing time increases depends on the concentration of an impurity material gas in a mixed gas being introduced into the vacuum container. The invention also makes it possible to obtain, relatively easily, by in-situ monitoring, a measurement quantity that strongly correlates with such particles as ions or radicals generated by dissociation or ionization of an impurity material gas in plasma.

### Embodiment 2

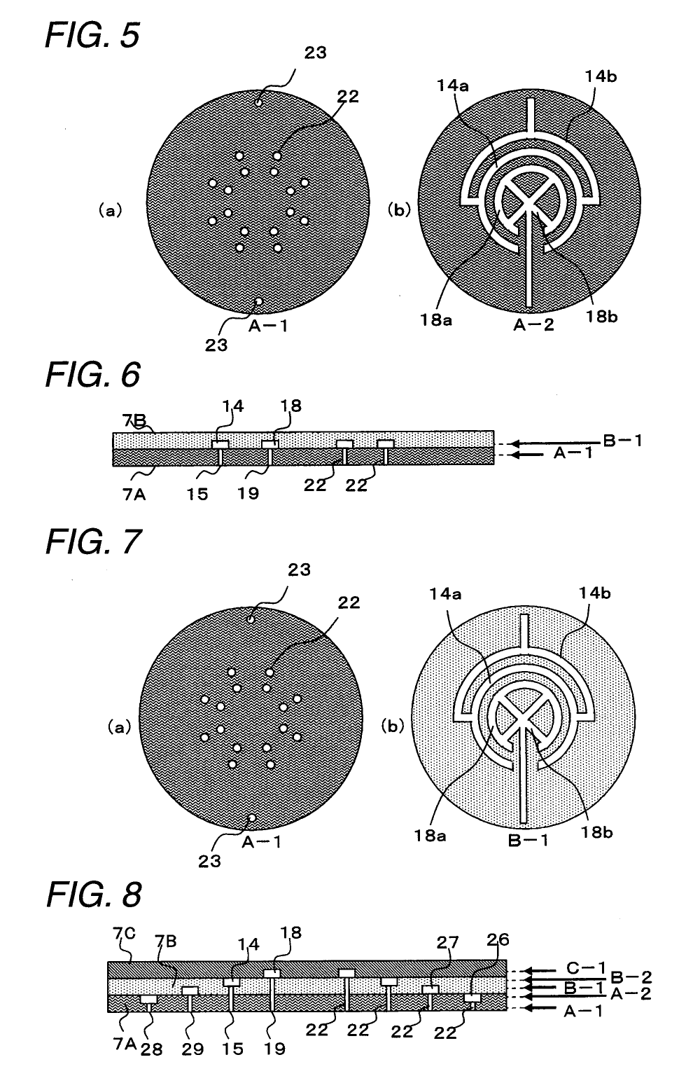

A second embodiment of the invention will be described below with reference to FIGS. 4 and 5. Most of the configuration of a plasma processing apparatus used in the second embodiment is the same as the corresponding part of the configuration of the plasma processing apparatus used in the above-described first embodiment, and hence will not be described.

FIG. 4 shows a detailed cross section of a dielectric window 7. As seen from this figure, the dielectric window 7 is composed of two dielectric plates 7A and 7B. Grooves 14 and 18 as gas passages are formed in the one surface of the dielectric plate 7A. Gas flow-out holes 15 and 19 formed in the dielectric plate 7A which is closest to the sample electrode 6 communicate with the grooves 14 and 18 inside the dielectric window 7.

The above structure realizes the state that the gas supply apparatus are connected to the respective grooves independently of each other and thereby makes it possible to perform a gas flow-out control very precisely.

FIGS. 5(a) and 5(b) are sectional views, taken along respective lines A-1 and A-2 in FIG. 4, of the dielectric plate 7A. As shown in FIG. 5(a) which is a sectional view taken at position A-1, through-holes 22 which connect the grooves 14 and 18 to the gas flow-out holes and through-holes 23 which allow the grooves 14 and 18 to communicate with the window frame are formed in a lower layer (located on the sample electrode side) of the dielectric plate 7A.

As shown in FIG. 5(b) which is a sectional view taken at position A-2, (first) grooves 14a and 14b and (second) grooves 18a and 18b are formed in an upper layer (located on the opposite side to the sample electrode 6) of the dielectric plate 7A. As shown in FIG. 5(a) which is a sectional view taken at position A-1, the through-holes 22 that connect the groove 14 to the gas flow-out holes 15 are formed right under the groove 14a. That is, the groove 14a is a portion where the through-holes 22 that connect the groove 14 to the gas flow-out holes 15 are arranged approximately at regular intervals. The groove 14b is a portion where no through-holes for connecting the groove 14 to the gas flow-out holes 15 are arranged. As is apparent from FIG. 5(b) which is a sectional view taken at position A-2, the connecting portion of the gas supply apparatus 2 and the groove 14 communicates with the groove 14a via two paths (groove 14b) which have approximately the same lengths.

As shown in FIG. 5(a) which is a sectional view taken at position A-1, the through-holes 22 that connect the groove 18 to the gas flow-out holes 19 are formed right under the groove 18a. That is, the groove 18a is a portion where the through-holes 22 that connect the groove 18 to the gas flow-out holes 19 are arranged approximately at regular intervals. The groove 18b is a portion where no through-holes for connecting the groove 18 to the gas flow-out holes 19 are arranged. As is apparent from FIG. 5(b) which is a sectional view taken at position A-2, the connecting portion of the gas supply apparatus 16 and the groove 18 communicates with the groove 18a via four paths (groove 18b) which have approximately the same lengths.

As is apparent from FIG. 5(b) which is a sectional view taken at position A-2, the groove 14b is formed outside the groove 14a and the groove 18b is formed inside the groove 18a. Forming, in this manner, the grooves adjacent to the joining interface between the dielectric plates 7A and 7B so that they do not interfere with each other makes it possible to independently control the rates at which gases are supplied from the gas flow-out holes 15 and the gas flow-out holes 19.

### Embodiment 3

A third embodiment of the invention will be described below with reference to FIGS. 6 and 7. Most of the configuration of a plasma processing apparatus used in the third embodiment is the same as the corresponding part of the configuration of the plasma processing apparatus used in the above-described first embodiment, and hence will not be described.

FIG. 6 shows a detailed cross section of a dielectric window 7. As seen from this figure, the dielectric window 7 is composed of two dielectric plates 7A and 7B. Grooves 14 and 18 as gas passages are formed in the one surface of the dielectric plate 7B. Gas flow-out holes 15 and 19 formed in the dielectric plate 7A which is closest to the sample electrode 6 communicate with the grooves 14 and 18 inside the dielectric window 7.

The above structure realizes the state that the gas supply apparatus are connected to the respective grooves independently of each other and thereby makes it possible to perform a gas flow-out control very precisely.

FIGS. 7(a) and 7(b) are plan views, taken along respective lines A-1 and B-1 in FIG. 6, of the dielectric plate 7A or 7B. As shown in FIG. 7(a) which is a sectional view taken at position A-1, through-holes 22 which connect the grooves 14 and 18 to the gas flow-out holes 15 and 19 and through-holes 23 which allow the grooves 14 and 18 to communicate with the window frame are formed in the dielectric plate 7A. As shown in FIG. 7(b) which is a sectional view taken at position B-1, (first) grooves 14a and 14b and (second) grooves 18a and 18b are formed in a lower layer (located on the side opposed to the sample electrode 6) of the dielectric plate 7B.

As shown in FIG. 7(a) which is a sectional view taken at position A-1, the through-holes 22 that connect the groove to the gas flow-out holes 15 are formed right under the groove 14a. That is, the groove 14a is a portion where the through-holes 22 that connect the groove 14 to the gas flow-out holes 15 are arranged approximately at regular intervals. The groove 14b is a portion where no through-holes for connecting the groove 14 to the gas flow-out holes 15 are arranged. As is apparent from FIG. 7(b) which is a sectional view taken at position B-1, the connecting portion of the gas supply apparatus 2 and the groove communicates with the groove 14a via two paths (groove 14b) which have approximately the same lengths.

As shown in FIG. 7(a) which is a sectional view taken at position A-1, the through-holes 22 that connect the groove to the gas flow-out holes 19 are formed right under the groove 18a. That is, the groove 18a is a portion where the through-holes 22 that connect the groove 18 to the gas flow-out holes 19 are arranged approximately at regular intervals. The groove 18b is a portion where no through-holes for connecting the groove 18 to the gas flow-out holes 19 are arranged. As is apparent from FIG. 7(b) which is a sectional view taken at position B-1, the connecting portion of the gas supply apparatus 16 and the groove 18 communicates with the groove 18a via four paths (groove 18b) which have approximately the same lengths.

As is apparent from FIG. 7(b) which is a sectional view taken at position B-1, the groove 14b is formed outside the groove 14a and the groove 18b is formed inside the groove 18a. Forming, in this manner, the grooves adjacent to the joining interface between the dielectric plates 7A and 7B so that they do not interfere with each other makes it possible to independently control the rates at which gases are supplied from the gas flow-out holes 15 and the gas flow-out holes 19.

### Embodiment 4

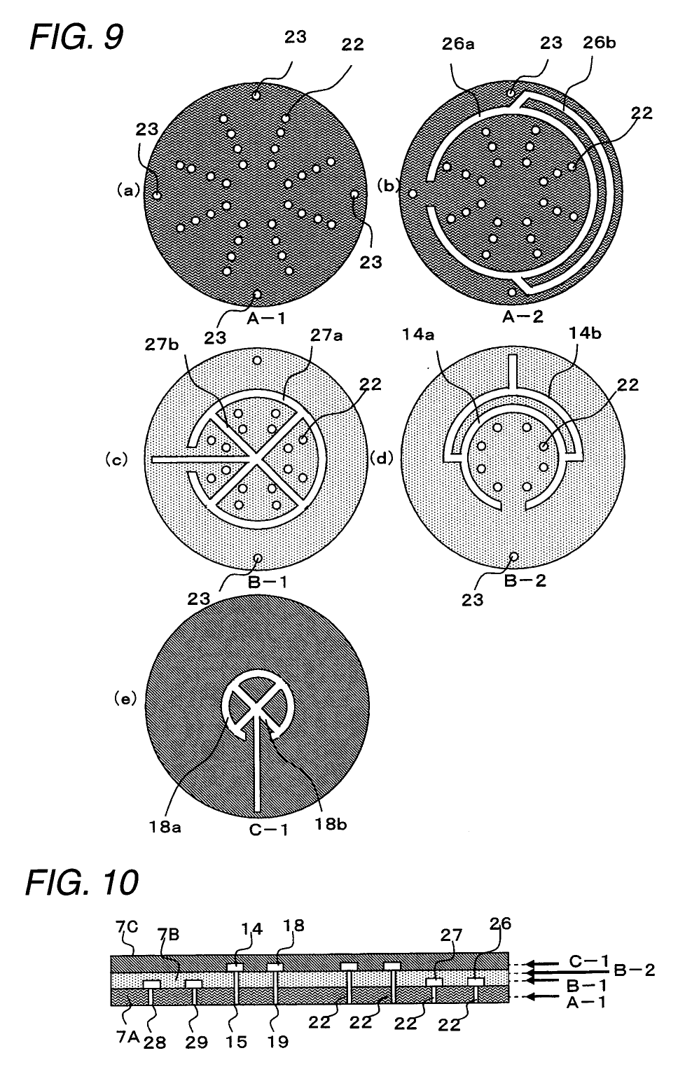

A fourth embodiment of the invention will be described below with reference to FIGS. 8 and 9. Most of the configuration of a plasma processing apparatus used in the fourth embodiment is the same as the corresponding part of the configuration of the plasma processing apparatus used in the above-described first embodiment, and hence will not be described. However, four systems of gas supply apparatus are provided rather than two systems.

FIG. 8 shows a detailed cross section of a dielectric window 7. As seen from this figure, the dielectric window 7 is composed of three dielectric plates 7A, 7B, and 7C. Grooves 14, 18, 26, and 27 as gas passages are formed in the different surfaces of the dielectric plates 7A, 7B, and 7C. Gas flow-out holes 15, 19, 28, and 29 formed in the dielectric plate 7A which is closest to the sample electrode 6 communicate with the grooves 14, 18, 26 and 27 inside the dielectric window 7.

The above structure realizes the state that the gas supply apparatus are connected to the respective grooves independently of each other and thereby makes it possible to perform a gas flow-out control very precisely.

FIGS. 9(a)-9(e) are sectional views, taken along respective lines A-1, A-2, B-1, B-2, and C-1 in FIG. 8, of the dielectric plates 7A, 7B and 7C which constitute the dielectric window 7. As shown in FIG. 9(a) which is a sectional view taken at position A-1, through-holes 22 which connect the grooves 14, 18 26 and 27 to the gas flow-out holes 15, 19, 28 and 29 and through-holes 23 which allow the grooves 14, 18, 26 and 27 to communicate with the window frame are formed in a lower layer (located on the sample electrode side 6) of the dielectric plate 7A.

As shown in FIG. 9(b) which is a sectional view taken at position A-2, (third) grooves 26a and 26b are formed in an upper layer (located on the opposite side to the sample electrode 6) of the dielectric plate 7A. As shown in FIG. 9(a) which is a sectional view taken at position A-1, the through-holes 22 that connect the groove 26 to the gas flow-out holes 28 are formed right under the groove 26a. That is, the groove 26a is a portion where the through-holes 22 that connect the groove 26 to the gas flow-out holes 28 are arranged approximately at regular intervals. The groove 26b is a portion where no through-holes for connecting the groove 26 to the gas flow-out holes 28 are arranged. As is apparent from FIG. 9(b), the connecting portion of the gas supply apparatus for supplying a gas to the groove 26 communicates with the groove 26a via two paths (groove 26b) which have approximately the same lengths. The through-holes 22 that allow the other grooves 14, 18 and 27 to communicate with the corresponding gas flow-out holes 15, 19 and 29 are formed on the side of the groove 26a that is closer to the center of the dielectric plate 7A.

As shown in FIG. 9(c) which is a sectional view taken at position B-1, (fourth) grooves 27a and 27b are formed in a lower layer (located on the sample electrode side) of the dielectric plate 7B. As shown in FIG. 9(b) which is a sectional view taken at position A-2, the through-holes 22 that connect the groove 27 to the gas flow-out holes 29 are formed right under the groove 27a. That is, the groove 27a is a portion where the through-holes 22 that connect the groove 27 to the gas flow-out holes 29 are arranged approximately at regular intervals. The groove 27b is a portion where no through-holes for connecting the groove 27 to the gas flow-out holes 29 are arranged. As is apparent from FIG. 9(c) which is a sectional view taken at position B-1, the connecting portion of the gas supply apparatus for supplying a gas to the groove 27 communicates with the groove 27a via four paths (groove 27b) which have approximately the same lengths. The through-holes 22 that allow the other grooves 14 and 18 to communicate with the corresponding gas flow-out holes and 19 are formed on the side of the groove 27a that is closer to the center of the dielectric plate 7B.

As is apparent from FIGS. 9(b) and 9(c) which are sectional views taken at positions A-2 and B-1, respectively, the groove 26b is formed outside the groove 26a and the groove 27b is formed inside the groove 27a. Forming, in this manner, the grooves in the joining surfaces of the dielectric plates 17A and 17B so that they do not interfere with each other makes it possible to independently control the rates at which gases are supplied from the gas flow-out holes 28 and the gas flow-out holes 29. As shown in FIG. 9(d) which is a sectional view taken at position B-2, (first) grooves 14a and 14b are formed in an upper layer (located on the opposite side to the sample electrode 6) of the dielectric plate 7B. As shown in FIGS. 9(a)-9(c) which are sectional views taken at positions A-1, A-2, and B-1, the through-holes 22 that connect the groove 14 to the gas flow-out holes 15 are formed right under the groove 14a.

That is, the groove 14a is a portion where the through-holes 22 that connect the groove 14 to the gas flow-out holes 15 are arranged approximately at regular intervals. The groove 14b is a portion where no through-holes for connecting the groove 14 to the gas flow-out holes 15 are arranged. As is apparent from FIG. 9(d) which is a sectional view taken at position B-2, the connecting portion of the gas supply apparatus 2 and the groove 14 communicates with the groove 14a via two paths (groove 14b) which have approximately the same lengths. The through-holes 22 that allow the other groove 18 to communicate with the corresponding gas flow-out holes 19 are formed on the side of the groove 14a that is closer to the center of the dielectric plate 7B.

As shown in FIG. 9(e) which is a sectional view taken at position C-1, (second) grooves 18a and 18b are formed in a lower layer (located on the sample electrode side) of the dielectric plate C. As shown in FIGS. 9(a)-9(d) which are sectional views taken at position A-1, A-2, B-1, and B-2, the through-holes 22 that connect the groove 18 to the gas flow-out holes 19 are formed right under the groove 18a. That is, the groove 18a is a portion where the through-holes 22 that connect the groove 18 to the gas flow-out holes 19 are arranged approximately at regular intervals. The groove 18b is a portion where no through-holes for connecting the groove 18 to the gas flow-out holes 19 are arranged. As is apparent from FIG. 9(e) which is a sectional view taken at position C-1, the connecting portion of the gas supply apparatus 16 and the groove 18 communicates with the groove 18a via four paths (groove 18b) which have approximately the same lengths.

As is apparent from FIGS. 9(d) and 9(e) which are sectional views taken at positions B-2 and C-1, respectively, the groove 14b is formed outside the groove 14a and the groove 18b is formed inside the groove 18a. Forming, in this manner, the grooves in the joining surfaces of the dielectric plates 7B and 7C so that they do not interfere with each other makes it possible to independently control the rates at which gases are supplied from the gas flow-out holes 15 and the gas flow-out holes 19.

### Embodiment 5

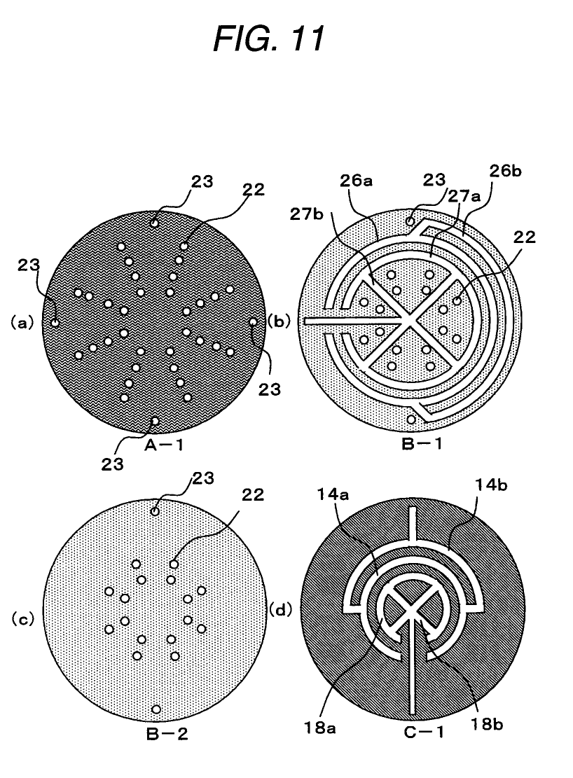

A fifth embodiment of the invention will be described below with reference to FIGS. 10 and 11. Most of the configuration of a plasma processing apparatus used in the fifth embodiment is the same as the corresponding part of the configuration of the plasma processing apparatus used in the above-described first embodiment, and hence will not be described. However, four systems of gas supply apparatus are provided rather than two systems.

FIG. 10 shows a detailed cross section of a dielectric window 7. As seen from this figure, the dielectric window 7 is composed of three dielectric plates 7A, 7B, and 7C. Grooves 14, 18, 26, and 27 as gas passages are formed in the single surfaces of the dielectric plates 7B and 7C. Gas flow-out holes 15, 19, 28, and 29 formed in the dielectric plate 7A which is closest to the sample electrode 6 communicate with the grooves 14, 18, 26 and 27 inside the dielectric window 7.

The above structure realizes the state that the gas supply apparatus are connected to the respective grooves independently of each other and thereby makes it possible to perform a gas flow-out control very precisely.

FIGS. 11(a)-11(d) are sectional views, taken along respective lines A-1, B-1, B-2, and C-1 in FIG. 10, of the dielectric plates 7A, 7B and 7C which constitute the dielectric window 7. As shown in FIG. 11(a) which is a sectional view taken at position A-1, through-holes 22 which connect the grooves 15, 19, 26 and to the gas flow-out holes 15, 19, 28 and 29 and through-holes 23 which allow the grooves 15, 19, 28 and 29 to communicate with the window frame are formed in the dielectric plate 7A. As shown in FIG. 11(b) which is a sectional view taken at position B-1, (third) grooves 26a and 26b are formed in a lower layer (located on the sample electrode side) of the dielectric plate 7B. As shown in FIG. 11(a), the through-holes 22 that connect the groove 26 to the gas flow-out holes 28 are formed right under the groove 26a. That is, the groove 26a is a portion where the through-holes 22 that connect the groove 26 to the gas flow-out holes 28 are arranged approximately at regular intervals. The groove 26b is a portion where no through-holes for connecting the groove 26 to the gas flow-out holes 28 are arranged. As is apparent from FIG. 11(b) which is a sectional view taken at position B-1, the connecting portion of the gas supply apparatus for supplying a gas to the groove 26 communicates with the groove 26a via two paths (groove 26b) which have approximately the same lengths.

(Fourth) grooves 27a and 27b are also formed in the lower layer (located on the sample electrode side) of the dielectric plate 7B. As shown in FIG. 11(a) which is a sectional view taken at position A-1, the through-holes 22 that connect the groove 27 to the gas flow-out holes 29 are formed right under the groove 27a. That is, the groove 27a is a portion where the through-holes 22 that connect the groove 27 to the gas flow-out holes 29 are arranged approximately at regular intervals. The groove 27b is a portion where no through-holes for connecting the groove 27 to the gas flow-out holes 29 are arranged. As is apparent from FIG. 11(b) which is a sectional view taken at position B-1, the connecting portion of the gas supply apparatus for supplying a gas to the groove 27 communicates with the groove 27a via four paths (groove 27b) which have approximately the same lengths. The through-holes 22 that allow the other grooves 14 and 18 to communicate with the corresponding gas flow-out holes 15 and 19 are formed on the side of the groove 27a that is closer to the center of the dielectric plate 7B.

As is apparent from FIG. 11(b) which is a sectional view taken at positions B-1, the groove 26b is formed outside the groove 26a and the groove 27b is formed inside the groove 27a. Forming, in this manner, the grooves adjacent to the joining interface between the dielectric plates 7A and 7B so that they do not interfere with each other makes it possible to independently control the rates at which gases are supplied from the gas flow-out holes 28 and the gas flow-out holes 29.

As shown in FIG. 11(c) which is a sectional view taken at position B-2, the through-holes 22 that connect the grooves and 18 to the gas flow-out holes 15 and 19 and the through holes 23 that allow the grooves 14 and 18 to communicate with the window frame are formed in an upper layer (located on the opposite side to the sample electrode 6) of the dielectric plate 7B.

As shown in FIG. 11(d) which is a sectional view taken at position C-1, (first) grooves 14a and 14b are formed in a lower layer (located on the sample electrode side) of the dielectric plate 7C. As shown in FIGS. 11(a), 11(b), and 11(c) which are sectional views taken at positions A-1, B-1, and B-2, the through-holes 22 that connect the groove 14 to the gas flow-out holes 15 are formed right under the groove 14a. That is, the groove 14a is a portion where the through-holes 22 that connect the groove 14 to the gas flow-out holes 15 are arranged approximately at regular intervals. The groove 14b is a portion where no through-holes for connecting the groove 14 to the gas flow-out holes 15 are arranged. As is apparent from FIG. 11(d) which is a sectional view taken at position C-1, the connecting portion of the gas supply apparatus 2 and the groove 14 communicates with the groove 14a via two paths (groove 14b) which have approximately the same lengths.

(Second) grooves 18a and 18b are also formed in the lower layer (located on the sample electrode side) of the dielectric plate 7C. As shown in FIGS. 11(a)-11(c) which are sectional views taken at position A-1, B-1, and B-2, the through-holes 22 that connect the groove 18 to the gas flow-out holes 19 are formed right under the groove 18a. That is, the groove 18a is a portion where the through-holes 22 that connect the groove 18 to the gas flow-out holes 19 are arranged approximately at regular intervals. The groove 18b is a portion where no through-holes for connecting the groove 18 to the gas flow-out holes 19 are arranged. As is apparent from FIG. 11(d) which is a sectional view taken at position C-1, the connecting portion of the gas supply apparatus 16 and the groove 18 communicates with the groove 18a via four paths (groove 18b) which have approximately the same lengths.

As is apparent from FIG. 11(d) which is a sectional view taken at position C-1, the groove 14b is formed outside the groove 14a and the groove 18b is formed inside the groove 18a. Forming, in this manner, the grooves adjacent to the joining interface between the dielectric plates 7B and 7C so that they do not interfere with each other makes it possible to independently control the rates at which gases are supplied from the gas flow-out holes 15 and the gas flow-out holes 19.

### Embodiment 6

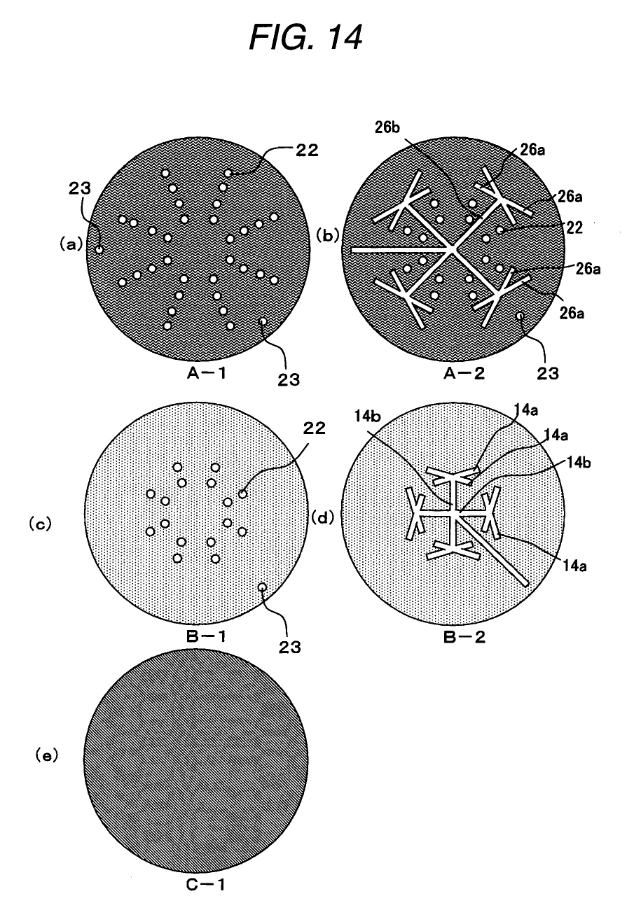

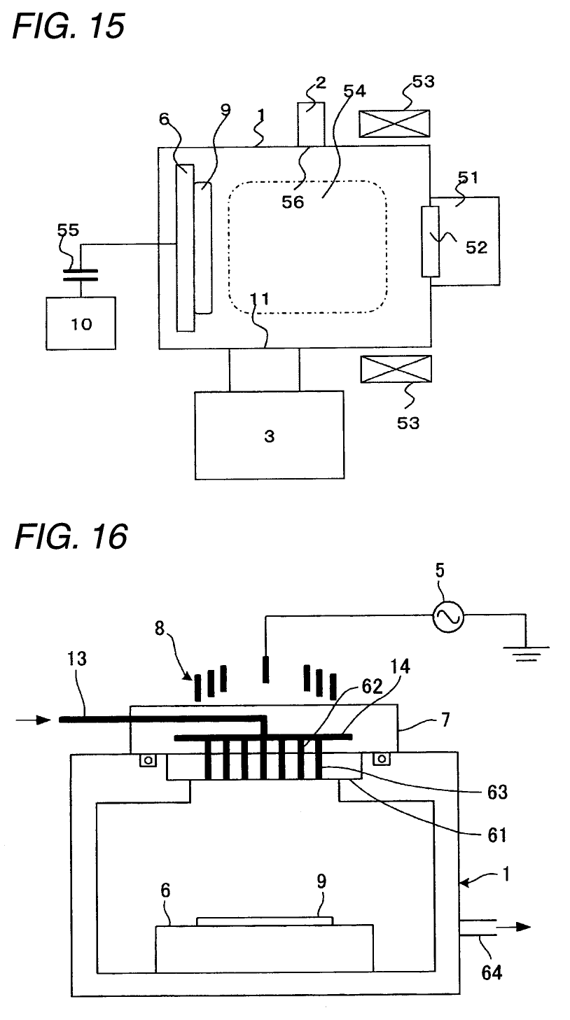

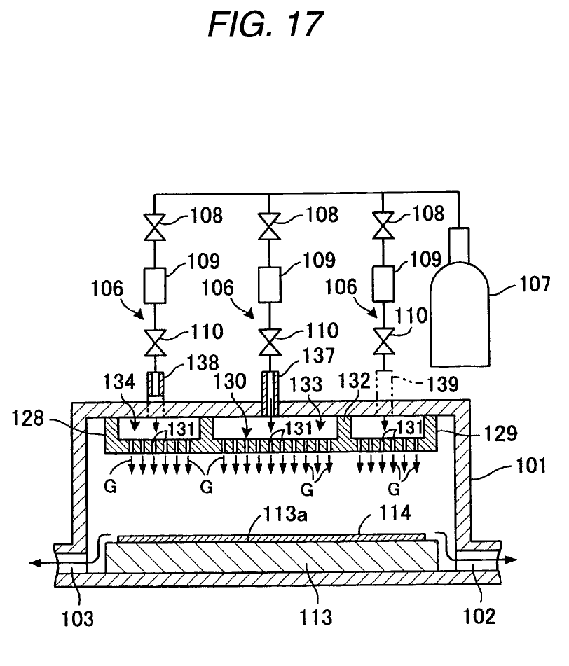

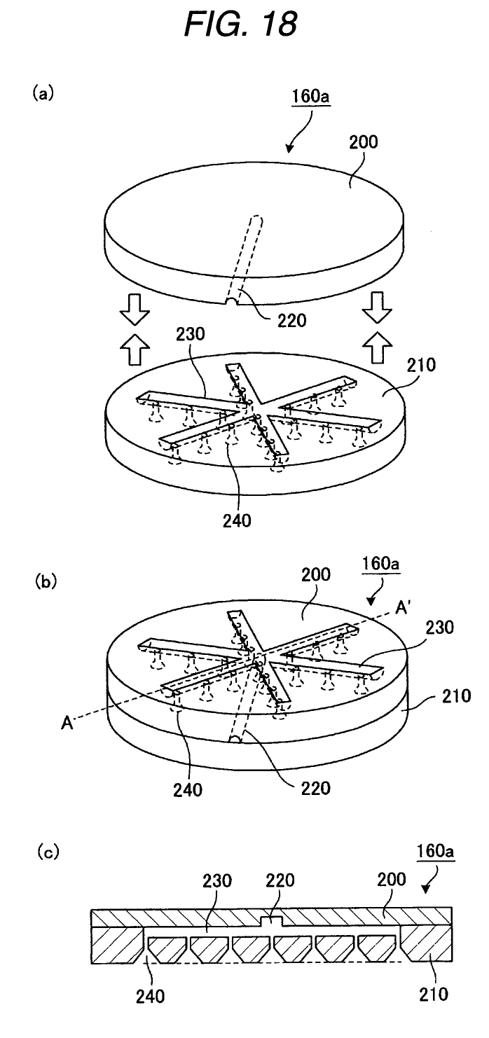

A sixth embodiment of the invention will be described below with reference to FIGS. 13 and 14. Most of the configuration of a plasma processing apparatus used in the sixth embodiment is the same as the corresponding part of the configuration of the above-described plasma processing apparatus, and hence will not be described in detail. As in the above-described fifth embodiment, a dielectric window is composed of three dielectric plates. The dielectric window of this embodiment is different from that of the fifth embodiment in that as shown in FIGS. 14(b) and 14(d) four grooves that communicate with through holes 22 that connect a groove to gas flow-out holes are formed so as to extend radially from each of points that are arranged at regular intervals on the same circle of a dielectric plate. This structure equalizes distances to the gas flow-out holes. On the other hand, two gas supply systems are provided.

FIG. 13 shows a detailed cross section of a dielectric window 7. As seen from this figure, also in this embodiment, the dielectric window 7 is composed of three dielectric plates 7A, 7B, and 7C. Grooves 14 and grooves 26 as gas passages are formed in the single surfaces of the dielectric plates 7A and 7B, respectively. Gas flow-out holes 15 and 28 formed in the dielectric plate 7A which is closest to the sample electrode 6 communicate with the grooves 14 and 26 inside the dielectric window 7.

The above structure realizes the state that the gas supply apparatus are connected to the respective sets of grooves 14 and 26 independently of each other and thereby makes it possible to perform a gas flow-out control even more precisely.

FIGS. 14(a)-14(e) are sectional views, taken along respective lines A-1, A-2, B-1, B-2, and C-1 in FIG. 13, of the dielectric plates 7A, 7B and 7C which constitute the dielectric window 7. As shown in FIG. 14(a) which is a sectional view taken at position A-1, through-holes 22 which connect the grooves 14 and 26 to the gas flow-out holes 15 and 28 and through-holes 23 which allow the grooves 14 and 26 to communicate with the window frame are formed in a lower layer (located on the sample electrode side 6) of the dielectric plate 7A.

As shown in FIG. 14(b) which is a sectional view taken at position A-2, grooves 26a and grooves 26b are formed in an upper layer (located on the opposite side to the sample electrode 6) of the dielectric plate 7A. As shown in FIG. 14(a) which is a sectional view taken at position A-1, the through-holes 22 that connect the grooves 26 to the gas flow-out holes 28 are formed right under the grooves 26a. That is, the grooves 26a are portions where the through-holes 22 that connect the grooves 26 to the gas flow-out holes 28 are arranged approximately at regular intervals. The grooves 26b are portions where no through-holes for connecting the grooves 26 to the gas flow-out holes 28 are arranged. As is apparent from FIG. 14(b), the connecting portion of the gas supply apparatus for supplying a gas to the groove 26 communicates with the grooves 26a via four paths (grooves 26b) and the four paths have approximately the same lengths. The through-holes that allow the other grooves to communicate with the corresponding gas flow-out holes 22 are formed on the side of the grooves 26a that is closer to the center of the dielectric plate 7A.

As shown in FIG. 14(c) which is a sectional view taken at position B-1, the through-holes 22 that penetrate through the dielectric plate 7B and allow the grooves 14a to communicate with the gas flow-out holes 15 are formed in a lower layer (located on the sample electrode side) of the dielectric plate 7B. As shown in FIG. 14(b) which is a sectional view taken at positions A-2, the through-holes 22 that connect the grooves to the gas flow-out holes 15 are formed right under the groove 14a. That is, the grooves 14a are portions where the through-holes 22 that connect the grooves 14 to the gas flow-out holes 15 are arranged approximately at regular intervals. The grooves 14b are portions where no through-holes for connecting the grooves 14 to the gas flow-out holes 15 are arranged. As is apparent from FIG. 14(c) which is a sectional view taken at position B-1, the connecting portion of the gas supply apparatus for supplying a gas to the groove 14 communicates with the grooves 14a via four paths (grooves 14b) which have approximately the same lengths. The through-holes 22 that allow the other grooves 26 to communicate with the corresponding gas flow-out holes are formed in the dielectric plate 7A outside the grooves 14a.

As seen from FIGS. 14(b) and 14(c) which are sectional views taken at positions A-2 and B-1, the four grooves 26a extend radially from the outside end of each groove 26b. Forming, in this manner, the grooves 26a and 26b adjacent to the joining interface between the dielectric plates 7A and 7B so that they do not interfere with each other makes it possible to control, with high accuracy, the rate at which a gas is supplied from the gas flow-out holes 28.

As shown in FIG. 14(d) which is a sectional view taken at position B-2, the grooves 14a and the grooves 14b are formed in an upper layer (located on the opposite side to the sample electrode 6) of the dielectric plate 7B. The grooves 14b extend radially in four directions from the center of the dielectric plate 7B and the grooves 14a extend radially from the tip of each groove 14b. As shown in FIGS. 14(a)-14(c) which are sectional views taken at position A-1, A-2, and B-1, respectively, the through-holes 22 that connect the grooves 14 to the gas flow-out holes 15 are formed right under the grooves 14a.

That is, the grooves 14a are portions where the through-holes 22 that connect the grooves 14 to the gas flow-out holes 15 are arranged approximately at regular intervals. The grooves 14b are portions where no through-holes for connecting the grooves 14 to the gas flow-out holes 15 are arranged. As is apparent from FIG. 14(d) which is a sectional view taken at position B-2, the connecting portion of the gas supply apparatus 2 and the grooves 14 communicates with the grooves 14a via four independent radial paths (grooves 14b) and the four paths have approximately the same lengths.

As shown in FIG. 14(e) which is a sectional view taken at position C-1, no grooves are formed in a lower layer (located on the sample electrode side) of the dielectric plate 7C and hence the lower surface is a flat surface. This flat surface and the grooves 14 formed in the one surface of the dielectric plate 7B define the passages.

As seen from FIGS. 14(b) and 14(d) which are sectional views taken at positions A-2 and B-2, the four grooves 14a extend radially from the outer end of each of the four grooves 14b which themselves extend radially from the center of the dielectric plate 7B. And the four grooves 26a extend radially from the outer end of each of the four grooves 26b which themselves extend radially from the center of the dielectric plate 7A. Forming, in this manner, the grooves in the joining surfaces of the dielectric plates 7A and 7B so that they do not interfere with each other makes it possible to independently control, with high controllability, the rates at which gases are supplied from the gas flow-out holes 15 and the gas flow-out holes 28.

As for the shape of the vacuum container, the type and the manner of disposition of the plasma source, etc. in the application ranges of the invention, only part of various variations have been described in the above-described embodiments of the invention. It goes without saying that various variations other than the above-described ones are possible in applying the invention.

For example, the coil 8 may be a planar one. Instead of using the coil as an electromagnetic coupling device for generating an electromagnetic filed in the vacuum container through the dielectric window, an antenna for exciting helicon wave plasma, magnetically neutral loop plasma, microwave plasma with a magnetic field (electron cyclotron resonance plasma), or microwave surface-wave plasma without a magnetic field may be used. A parallel-plane plasma source as shown in FIG. 9 may also be used. Capable of generating high-density plasma, these electromagnetic coupling devices which generate an electromagnetic field in a vacuum container through a dielectric window make it possible to attain high processing speeds.

However, the use of an induction-coupling plasma source with a coil is preferable in apparatus configuration because it simplifies the apparatus configuration, reduces the cost and the probability of occurrence of trouble, and makes it possible to generate plasma efficiently.

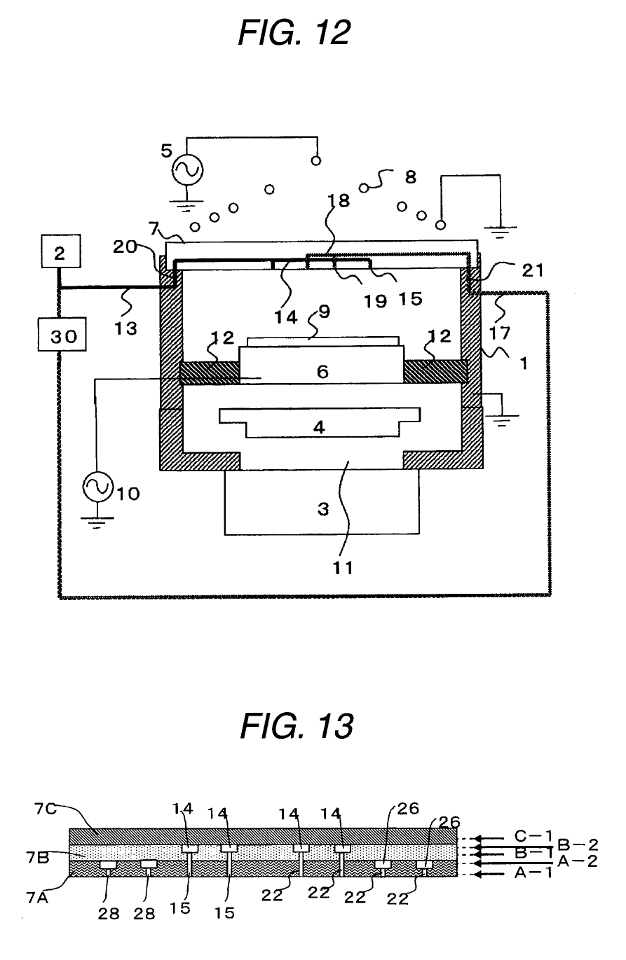

In the above embodiments, the independent gas supply apparatus are provided for the respective grooves or sets of grooves 14 and 18. Alternatively, as shown in FIG. 12, a control valve 30 may be provided which can vary the conductance ratio between gas passages that allow a gas supply apparatus 2 to communicate with respective grooves 14 and 18. A variable orifice, for example, can be used properly as the control valve 30. Although this configuration cannot change the concentrations of gases that are introduced from the sets of gas flow-out holes 15 and 19 that communicate with the respective grooves, it can minimize the number of gas supply apparatus each of which employs many components such as a mass flow controller and various valves and hence is effective in, for example, simplifying the apparatus configuration, reducing and apparatus size, and reducing the failure rate.

In the above embodiments, the gas flow-out holes corresponding to each groove are located at positions having approximately the same distance from the center of the dielectric window. However, the gas flow-out holes corresponding to each groove may be located at positions having different distances from the center of the dielectric window. For example, gas flow-out holes located on plural circles that are concentric with the dielectric window may correspond to a single groove.

### INDUSTRIAL APPLICABILITY

The plasma processing apparatus, the dielectric window used therein, and the manufacturing method of such a dielectric window according to the invention can provide a plasma processing apparatus capable of realizing plasma doping that is superior in the uniformity of the concentration of an impurity introduced into a surface layer of a sample and plasma processing that is superior in the in-plane uniformity of processing. As such, the invention can be applied to semiconductor impurity doping processes, the manufacture of thin-film transistors used in liquid crystal devices, and other uses such as etching, deposition, and surface property modification of various materials.

1. A plasma processing apparatus having a vacuum container, a sample electrode which is disposed inside the vacuum container and is to be mounted with a sample, a gas supply apparatus for supplying a gas to inside the vacuum container, plural gas flow-out holes formed in a dielectric window which is opposed to the sample electrode, an exhaust apparatus for exhausting the vacuum container, a pressure control device for controlling pressure in the vacuum container, and an electromagnetic coupling device for generating an electromagnetic field inside the vacuum container,
wherein the dielectric window is composed of plural dielectric plates, grooves are formed in at least one of two confronting surfaces of the dielectric plates, gas passages are formed by the grooves and a flat surface of a dielectric plate opposed to the grooves, and gas supply portions for supplying the grooves with gases coming from the gas supply apparatus are provided; and
the gas flow-out holes which are formed in a dielectric plate that is closest to the sample electrode communicate with the grooves inside the dielectric window.

2. The plasma processing apparatus according to claim 1, wherein the grooves form plural passage systems that do not communicate with each other.

3. The plasma processing apparatus according to claim 2, wherein each of the passage systems is composed of plural passages that do not allow the grooves to communicate with each other.

4. The plasma processing apparatus according to claim 2, wherein the passage systems are formed so that conductances of gas passages of the grooves from the gas supply portions to the gas flow-out holes can be controlled independently of each other.

5. The plasma processing apparatus according to claim 4, wherein gases that are flowed out of the passage systems have an approximately uniform distribution on a surface of the sample.

6. The plasma processing apparatus according to claim 2, wherein the gas flow-out holes communicate with first and second passage systems which are arranged so as to assume concentric circles, and the first passage system has the gas supply portion inside the gas flow-out holes on the concentric circle and the second passage system has the gas supply portion outside the gas flow-out holes on the concentric circle.

7. The plasma processing apparatus according to claim 1, wherein conductances of gas passages of the grooves from the gas supply portions to the gas flow-out holes are set identical.

8. The plasma processing apparatus according to claim 1, wherein the grooves are formed in only one of first and second dielectric plates, the other dielectric plate has a flat surface, and the passages are formed by bonding the first and second dielectric plates together.

9. The plasma processing apparatus according to claim 6, wherein the first passage system has plural radial groove portions which extend radially from a center of the dielectric plate and a first circular groove portion which assumes a circular arc and communicates with the radial groove portions, and gas flow-out holes are formed so as to communicate with the first circular groove portion; and
the gas supply portion communicates with the radial groove portions at the center of the dielectric plate.

10. The plasma processing apparatus according to claim 9, wherein the second passage system has a second circular arc groove portion which assumes a circular arc and is formed outside the first circular arc groove portion and an outer groove which extends outward from the second circular arc groove portion, and that the gas supply portion communicates with the outer groove.

11. The plasma processing apparatus according to claim 1 which is a plasma doping apparatus comprising a heat processing section for forming a desired plasma distribution on a surface of a substrate to be processed and introducing the plasma into a surface layer of the substrate to be processed.

12. The plasma processing apparatus according to claim 1, wherein gas supply apparatus are connected to the respective grooves independently of each other.

13. The plasma processing apparatus according to claim 1, wherein the gas supply apparatus comprises a control valve for varying a conductance ratio between gas passages that allow the gas supply apparatus to communicate the respective grooves.

14. The plasma processing apparatus according to claim 1, wherein when each of the grooves is divided into a portion (a) where through-holes that connect the groove to the gas flow-out holes are arranged approximately at regular intervals and a portion (b) where no through-holes for connecting the groove to the gas flow-out holes are arranged, the connecting portion of the groove and the gas supply apparatus communicates with the portion (a) via plural paths as the portion (b) which have approximately the same lengths.

15. The plasma processing apparatus according to claim 7, wherein connecting portions of the portions (a) and (b) are arranged so as to be balanced almost completely with respect to the portion (a).

16. The plasma processing apparatus according to claim 1, wherein the dielectric window is composed of two dielectric plates; and when the two dielectric plates are referred to as dielectric plates A and B in ascending order of distance from the sample electrode, a first groove is formed in a surface of the dielectric plate A that is located on the opposite side to the sample electrode and a second groove is formed is a surface of the dielectric plate B that is opposed to the sample electrode.

17. The plasma processing apparatus according to claim 16, wherein the first groove communicates with part of the gas flow-out holes via through-holes formed in the dielectric plate A and the second groove communicates with the other gas flow-out holes via through-holes formed in the dielectric plate A.

18. The plasma processing apparatus according to claim 1, wherein the dielectric window is composed of two dielectric plates; and when the two dielectric plates are referred to as dielectric plates A and B in ascending order of distance from the sample electrode, first and second grooves are formed in a surface of the dielectric plate A that is located on the opposite side to the sample electrode or opposed to the sample electrode.

19. The plasma processing apparatus according to claim 18, wherein the first and second grooves communicate with the gas flow-out holes via through-holes formed in the dielectric plate A.

20. The plasma processing apparatus according to claim 1, wherein the dielectric window is composed of three dielectric plates; and when the three dielectric plates are referred to as dielectric plates A, B, and C in ascending order of distance from the sample electrode, a first groove is formed in a surface of the dielectric plate A that is located on the opposite side to the sample electrode, a second groove is formed in a surface of the dielectric plate B that is opposed to the sample electrode, a third groove is formed in a surface of the dielectric plate B that is located on the opposite side to the sample electrode, and a fourth groove is formed in a surface of the dielectric plate C that is opposed to the sample electrode.

21. The plasma processing apparatus according to claim 20, wherein the first and second grooves communicate with parts of the gas flow-out holes via through-holes formed in the dielectric plate A and the third and fourth grooves communicate with the other parts of gas flow-out holes via through-holes formed in the dielectric plates A and B.

22. The plasma processing apparatus according to claim 20, wherein the dielectric window is composed of three dielectric plates; and when the three dielectric plates are referred to as dielectric plates A, B, and C in ascending order of distance from the sample electrode, first and second grooves are formed in a surface of the dielectric plate A that is located on the opposite side to the sample electrode or a surface of the dielectric plate B that is opposed to the sample electrode and third and fourth grooves are formed in a surface of the dielectric plate B that is located on the opposite side to the sample electrode or a surface of the dielectric plate C that is opposed to the sample electrode.

23. The plasma processing apparatus according to claim 22, wherein the first and second grooves communicate with parts of the gas flow-out holes via through-holes formed in the dielectric plate A and the third and fourth grooves communicate with the other parts of gas flow-out holes via through-holes formed in the dielectric plates A and B.

24. The plasma processing apparatus according to claim 6, wherein:
the first passage system has plural first radial groove portions which extend radially from a center of the dielectric plate and second radial groove portions which extend radially from an outer end of each of the first radial groove portions so as to communicate with the first radial groove portions, and gas flow-out holes are formed so as to communicate with tips of the second radial groove portions; and
the gas supply portion communicates with the first radial groove portions at the center of the dielectric plate.

25. A plasma processing method for processing a substrate to be processed by generating gas plasma containing impurity ions by operating an electromagnetic coupling means opposed to a sample electrode which is disposed inside a vacuum container and mounted with the substrate to be processed while supplying a gas containing an impurity to inside the vacuum container at a prescribed rate and a prescribed concentration and controlling pressure in the vacuum container to a prescribed value, comprising the steps of:
giving a distribution to a concentration or a supply rate of a gas containing the impurity that is supplied to a surface of the substrate to be processed.

26. The plasma processing method according to claim 25, wherein an inside area and an outside area of the substrate to be processed is given different distributions of the concentration or the supply rate of the gas supplied.

27. The plasma processing method according to claim 25, wherein the gas concentration distribution is such that the concentration has a peak in a region having a prescribed distance from a center of the substrate to be processed.

28. The plasma processing method according to claim 25, further comprising the step of forming an impurity region having a depth of 20 nm or less as measured from the surface of the substrate to be processed using the gas plasma.

29. A dielectric window formed by laminating at least two dielectric plates, wherein grooves are formed in at least one surface of at least two dielectric plates, and gas flow-out holes which are formed in a surface of a dielectric plate that is one surface of the dielectric window communicate with the grooves inside the dielectric window.

30. The dielectric window according to claim 29, wherein the dielectric plates are made of quartz glass.

31. A manufacturing method of a dielectric window, comprising the steps of:
forming through-holes in a dielectric plate (A);
forming grooves in a dielectric plate (B); and
placing in a vacuum and heating the dielectric plate (A) in which the through-holes are formed and the dielectric plate (B) in which the grooves are formed while bringing at least one surfaces of the dielectric plates (A) and (B) in contact with each other, and thereby joining the contacting surfaces together.

32. A manufacturing method of a dielectric window, comprising the steps of:
forming through-holes and grooves in a dielectric plate (A); and
placing in a vacuum and heating the dielectric plate (A) in which the through-holes and the grooves are formed and another dielectric plate (B) while bringing at least one surfaces of the dielectric plates (A) and (B) in contact with each other, and thereby joining the contacting surfaces together.
